(19) United States
(12) Patent Application Publication
(10) Pub. No.: US 2024/0378099 A1
(43) Pub. Date: Nov. 14, 2024

(54) COMPUTING SYSTEM FOR PREDICTING SUBSTITUTE COMPONENT OF ASSEMBLED PRODUCT

(71) Applicant: Microsoft Technology Licensing, LLC, Redmond, WA (US)

(72) Inventors: Ajay CHATTERJEE, Bengaluru (IN); Ranganathan SRIKANTH, Redmond, WA (US)

(73) Assignee: Microsoft Technology Licensing, LLC, Redmond, WA (US)

(21) Appl. No.: 18/315,327

(22) Filed: May 10, 2023

(51) Int. Cl. G06F 11/00

(52) U.S. Cl. CPC G06F 11/008

(57) ABSTRACT

A computing system for predicting substitute or missing parts of an assembled product is provided, including a processor configured to execute a model training program configured to generate a component graph including a respective node for each of a plurality of component IDs of the assembled product of a computing system. The component graph includes node embeddings for each node, in which the node embeddings are computed such that nodes with similar features are closer in a node embedding space than nodes with dissimilar features. The processor is further configured to execute an embeddings comparison algorithm to compare embeddings of the component IDs to thereby identify a substitute component ID for a target node on the graph, and execute a life cycle analysis (LCA) program configured to compute an LCA result using an LCA algorithm based at least upon the substitute component ID.

### BACKGROUND

Life Cycle Assessment (LCA) is a process that evaluates the environmental impacts of products and services throughout their full life cycle. By providing a comprehensive view of the environmental impacts of a product or service, LCA helps quantify sustainability. For instance, LCA can be applied to quantify sustainability in cloud computing hardware. Accurate LCA for computer hardware equipment can enable an organization to better understand the environmental effects of its large computing systems such as cloud data centers. This understanding can help organizations make adjustments to purchasing, deployment, and utilization of such cloud hardware to better achieve sustainability goals.

### SUMMARY

A computing system for predicting substitute components of an assembled product is provided. According to one aspect, the computing system comprises a processor having associated memory storing instructions that cause the processor to execute a model training program configured to generate a component graph including a respective node for each of a plurality of component IDs of the assembled product. The component graph includes node embeddings for each node, in which the node embeddings are computed such that nodes with similar features are closer in a node embedding space than nodes with dissimilar features. The processor is further configured to execute an embeddings comparison algorithm to compare embeddings of the component IDs to thereby identify a substitute component ID for a target node on the graph. The LCA program can be further configured to execute a life cycle analysis (LCA) program configured to compute an LCA result using an LCA algorithm based at least upon the substitute component ID.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for predicting substitute components of an assembled product, according to one example implementation of the present disclosure.

FIG. 2 illustrates a schematic view of an example unsupervised learning stage and semi-supervised learning stage of a model training program of the system of FIG. 1.

FIG. 3 shows an example component graph generated based on component hierarchical data via the model training program of the system of FIG. 1.

FIG. 4 illustrates a schematic view of an example feedback training stage of the model training program of the system of FIG. 1.

FIG. 5 shows an example component graph with node embeddings in a reduced dimensionality node embedding space identifying a substitute component ID via the system of FIG. 1.

FIGS. 6A-6C show screens of an example graphical user interface (GUI) of the LCA program of the system of FIG. 1.

FIGS. 7A and 7B illustrate experimental results of the present trained model of the system of FIG. 1 with comparison to other conventional models performing a benchmark test.

FIG. 8 is a flowchart of a method for predicting substitute components of an assembled product according to one example configuration of the present disclosure.

FIG. 9 is a schematic view of an example computing system according to one implementation of the present disclosure.

### DETAILED DESCRIPTION

As discussed above, conducting an accurate Life Cycle Assessment (LCA) for an assembled product can help organizations better understand the environmental effects of the deployment and usage of such product. For example, one typical step of LCA is to determine an environmental effect such as the greenhouse gas emissions for a product. However, accurately estimating the greenhouse gas emissions produced during the life cycle of a product is a particularly challenging task. One approach to estimate a product's greenhouse gas emissions is by utilizing Bill of Materials (BOM) information, environmental impact data, and a Full Material Disclosures (FMD) of the components listed in the BOM. The FMD data is typically used with external environmental impact datasets to calculate the final environmental impact of a component. Conventional approaches in this technical field typically use custom metrics to compare BOMs and assume that a part database is well organized and can be compared easily. However, it is found that these assumptions do not hold at a large scale since not all BOMs contain the FMD data and other relevant properties and there are missing or incorrect properties. When BOM data is incomplete or inaccurate, LCA is difficult to perform with accuracy using these conventional techniques. For mass deployments of hardware, such as in a cloud data center, even small errors in BOM data can result in large errors in the greenhouse gas predictions for the entire fleet of deployed computer hardware equipment.

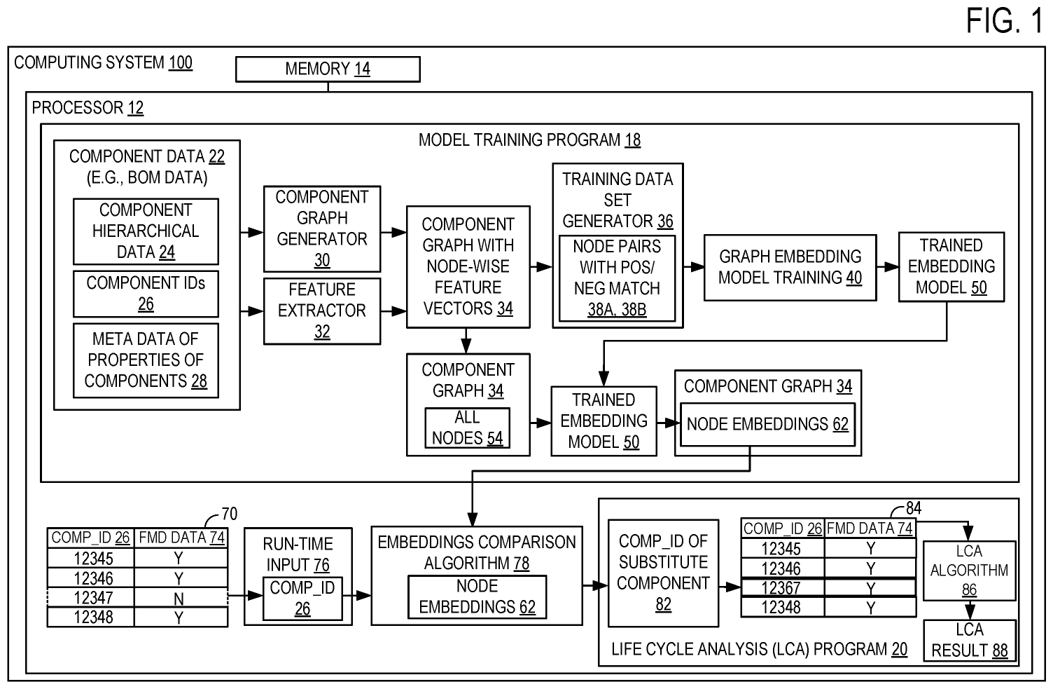

As schematically illustrated in FIG. 1, to address the issues identified above, a computing system 100 for predicting substitute components of an assembled product is provided. The assembled product may be any of a variety of types of assembled products, such as computer hardware including servers, laptops, desktops, smartphones, tablets, switches, or routers, vehicles such as an automobiles, trucks, or motorcycles, household appliances such as refrigerators, microwave ovens, dishwashers, and coffee makers, and consumer electronics devices such as televisions, headphones, audiovisual receivers, etc., as some examples. The substitute components may be for components that are missing from BOM data for the assembled product, or that are included in a BOM but have missing information for performing LCA, for example. Furthermore, the substitute components may also include components that are semantically similar, as determined in the manner described herein by comparison of tokenized embeddings of words describing the products. As illustrated in FIG. 1, the computing system 100 comprises a processor 12 having associated memory 14 storing instructions that cause the processor 12 to execute a model training program 18. The computing system 100 may include a cloud server platform including a plurality of server devices, and the processor 12 may be one processor of a single server device, or multiple processors of multiple server devices. The computing system 100 may also include one or more client devices in communication with the server devices, and one or more of processors 12 may be situated in such a client device. Below, the functions of computing system 100 as executed by the processor 12 are described by way of example, and this description shall be understood to include execution on one or more processors distributed among one or more of the devices discussed above.

Continuing with FIG. 1, the model training program 18 is configured to generate a component graph 34 including node embeddings for each node. To generate the component graph 34, the model training program 18 is initially configured to receive component data 22 such as bill of material (BOM) data, which is a comprehensive list of all the components, parts, assemblies, and sub-assemblies required to manufacture a product. It may also include item descriptions, specifications, quantities, and unique identifiers for each component. The component data 22 includes component hierarchical data 24, component IDs 26, and meta data 28 of properties of each of the component IDs 26. For example, in the case of computer hardware equipment in the form of a server, the component data 22 (e.g., BOM data) may include data on server components such as the motherboard, CPU, GPU or other hardware acceleration units, power supply, mass storage devices (e.g., non-volatile memory), volatile memory (e.g., RAM), cooling fans, cabling, interconnects, heat sinks, and other components in the server. The component hierarchical data 24 may be multi-level hierarchical data of an end assembled product (e.g., server, etc. as described above).

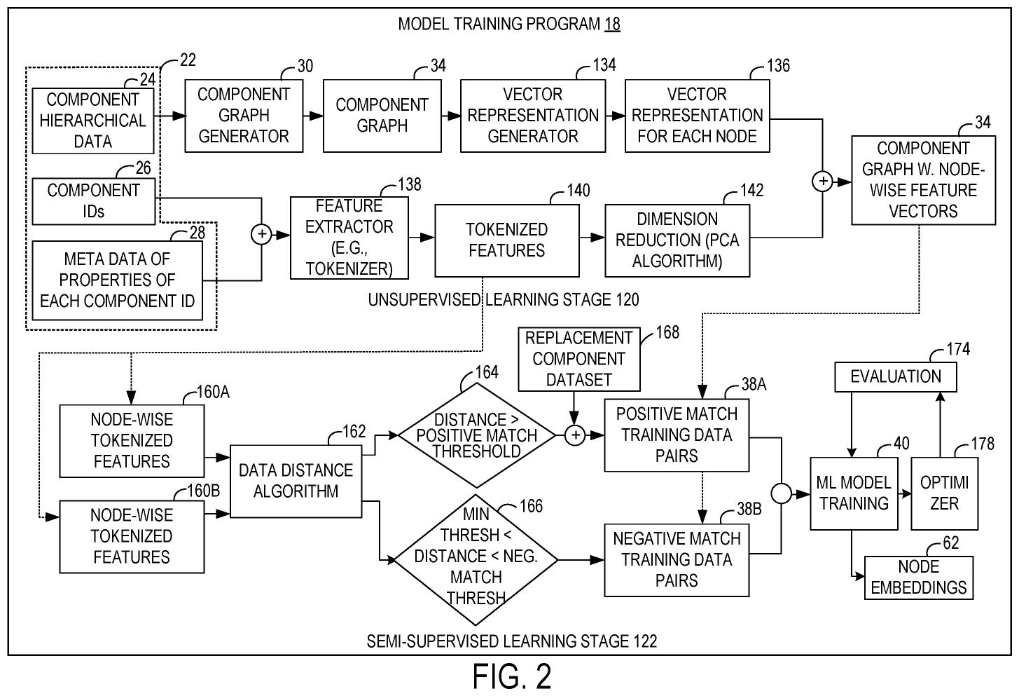

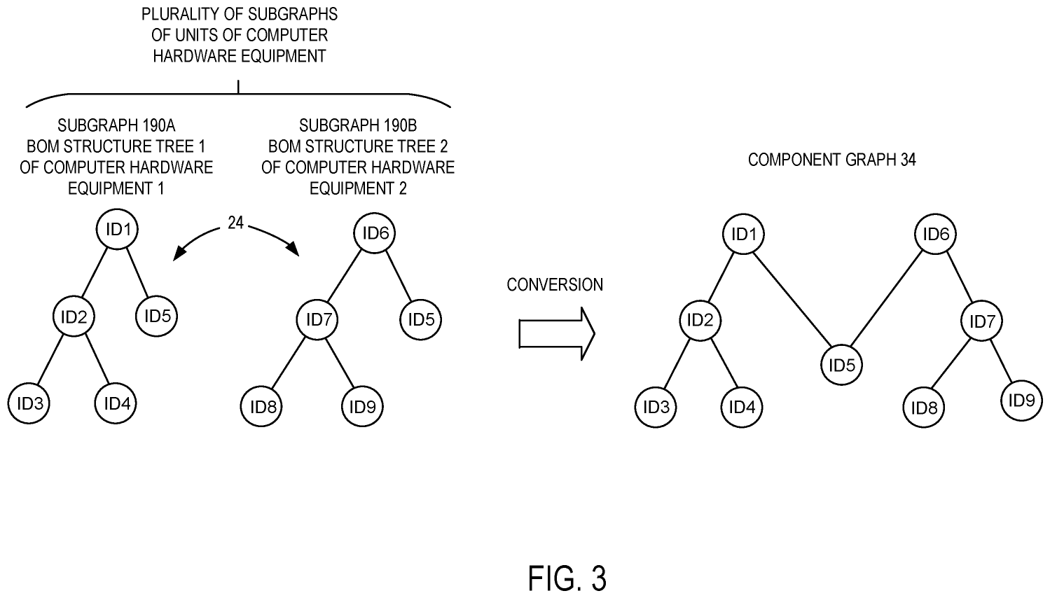

Based on the received component data 22, the model training program 18 is configured to generate, via a component graph generator 30 and a feature extractor 32, an initial instance of the component graph 34 with node-wise feature vectors. Turning briefly to FIG. 2, a schematic view of an example unsupervised learning stage 120 and semi-supervised learning stage 122 of the model training program 18 of the computing system 100 of FIG. 1 is illustrated. At the unsupervised learning stage 120, the model training program 18 is configured to generate, via a component graph generator 30, the initial instance of the component graph 34 based on the component hierarchical data 24 by identifying a common component and linking a plurality of subgraphs of units of the assembled product via the common component. This stage is referred to as unsupervised since there are no ground truth examples used during this stage. Turning briefly to FIG. 3, an example component graph 34 generated based on the component hierarchical data 24 via the model training program 18 is shown. Based on the component hierarchical data 24, the plurality of subgraphs 190A, 190B of units of the computer hardware equipment including BOM structure trees 1 and 2 for computer hardware equipment 1 and 2 are constructed. In the depicted example, the computer hardware equipment 1 includes a server (component ID #: ID1) that includes a motherboard (component ID #: ID2), including a 10 core CPU (component ID #: ID3) and a flash memory 2 GB (component ID #: ID4), and a solid state drive 480 GB (component ID #: ID5), and the computer hardware equipment 2 includes a server (component ID #: ID6) that includes a motherboard (component ID #: ID7), including a 12 core CPU (component ID #: ID8) and a flash memory 4 GB (component ID #: ID8), and a solid state drive 480 GB (ID5). In this example, the solid state drive 480 GB (ID5) is the common component between the computer hardware equipment 1 and the computer hardware equipment 2. These two subgraphs 190A, 190B are converted into the component graph 34 by linking the common component which is the solid state drive 480 GB (ID5), as shown at FIG. 3. It will be appreciated that this example is simplified for the sake of illustration, and in practice many more components and associated nodes would be included in the component graph.

Turning back to FIG. 2, at the unsupervised learning stage 120, the model training program 18 is configured to generate, via a vector representation generator 134, a vector representation for each node 136 of the component graph 34. Based on the component IDs 26 and the meta data of properties of the components indicated by each of the component IDs 26, the model training program 18 is further configured to generate, via a feature extractor 138, tokenized features 140, and apply a dimension reduction algorithm 142 to perform dimension reduction on the tokenized features 140. The model training program 18 is further configured to concatenate the vector representation for each node 136 and the tokenized features 140 to generate the component graph 34 with the node-wise feature vectors for each of the component IDs 26.

Referring back to FIG. 1, after generating the component graph 34 with the node-wise feature vectors for each of the component IDs 26, the model training program 18 is further configured to generate, via a training data set generator 36, a training data set by obtaining positive match training data pairs 38A and negative match training data pairs 38B for each of a plurality of pairs of the node-wise feature vectors, and performing graph embedding model training 40 and train a machine learning (ML) model based on the positive match training data pairs 38A and negative match training data pairs 38B, to thereby output a trained embedding model 50. The positive match training pairs 38A and negative match training pairs 38B are pairs of component IDs 26 for which respective tokenized features of the meta data 28 of properties of components are determined to negatively and positively match according to a data distance algorithm, as described below. Turning briefly to FIG. 2, at the semi-supervised learning stage 122, the model training program 18 is configured to generate a pair of the node-wise tokenized features 160A, 160B, which are per-node features from the tokenized features 140 extracted from the meta data 28 of properties of each component ID. The model training program 18 is further configured to apply a data distance algorithm 162 on the pair of the node-wise tokenized features 160A, 160B to generate the positive match training data pairs 38A and negative match training data pairs 38B. As shown at 164 and 166, the positive match training data pairs 38A are obtained when a Jaccard distance is larger than a positive match threshold, while the negative match training data pairs 38B are obtained when the Jaccard distance is larger than a minimum threshold and less than a negative match threshold for the pair of component IDs 26. The Jaccard distance is a measure of dissimilarity between two sample sets. It is calculated by finding the Jaccard index (Jaccard similarity coefficient) and subtracting it from 1. For example, if two sample sets have a Jaccard index of 80%, then the Jaccard distance would be 1−0.8=0.2 or 20%. Furthermore, the positive match training data pairs 38A may include the pairs of component IDs 26 included in a ground truth replacement component data set 168. This stage is referred to as semi-supervised because positive matching pairs are available as ground truth for some components but are not available for all possible components. Once the component IDs 26 for the positive matches and negative matches are identified, the associated node-wise feature vectors for each component ID in each training data pair are imported to form the positive match training data pairs 38B and the negative match training data pairs 38B.

Thus, the positive and negative match training data pairs 38A, 38B are pairs of node-wise feature vectors 34 computed during the unsupervised learning stage 120. The model training program 18 is configured to perform the machine learning (ML) model training 40 based on the obtained positive match training data pairs 38A and negative match training data pairs 38B to output the node embeddings 62 for each of the component IDs in the component graph from the trained ML model. The ML model may have an optimizer 178 which optimizes the model through evaluation 174.

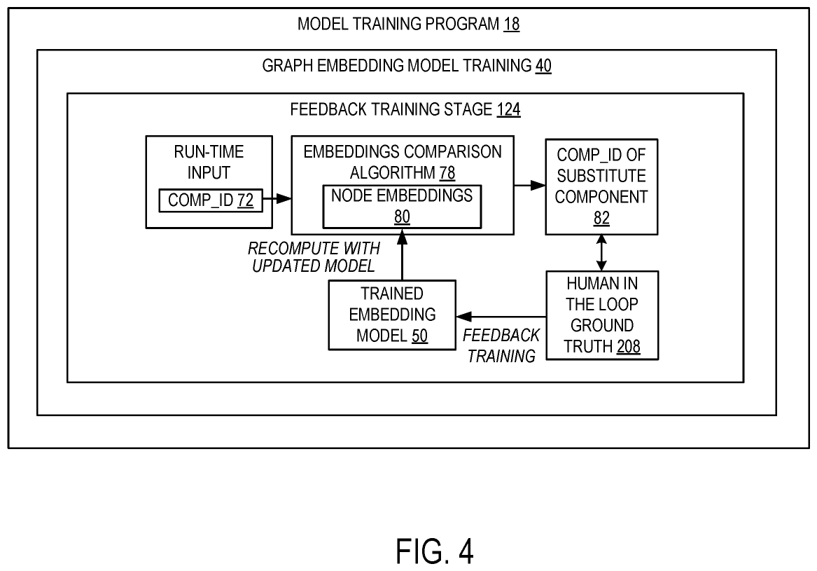

In addition to the unsupervised and semi-supervised learning discussed above, the model training program 18 is further configured to perform graph embedding model training 40 through feedback training. Turning briefly to FIG. 4, a schematic view of an example feedback training stage 124 of the model training program 18 is illustrated. The model training program 18 executes an embeddings comparison algorithm 78 to compare embeddings of the component IDs to identify a substitute component ID 82 for a target node on the graph. The program 18 also performs feedback training on the trained embedding model 50 via human in the loop ground truth 208 and recomputes with the updated model 50 to improve accuracy. In this stage, the output of the model is shown to a human in the loop, who provides confirmation of the accuracy or inaccuracy of the prediction. The human in the loop provides input that is used to perform feedback training of the ML model.

Turning back to FIG. 1, the model training program 18 is configured to feed the component graph 34 with node-wise feature vectors including all nodes 54 into the trained embedding model 50 to generate the component graph 34 including a respective node for each of a plurality of component IDs 26 of the assembled product, in which the component graph includes the node embeddings 62 for each node, and the node embeddings 62 are computed such that nodes with similar features are closer in a node embedding space than nodes with dissimilar features, as discussed above. Similar features are obtained by using component connections and metadata information to generate features that encode sematic similarity of the node.

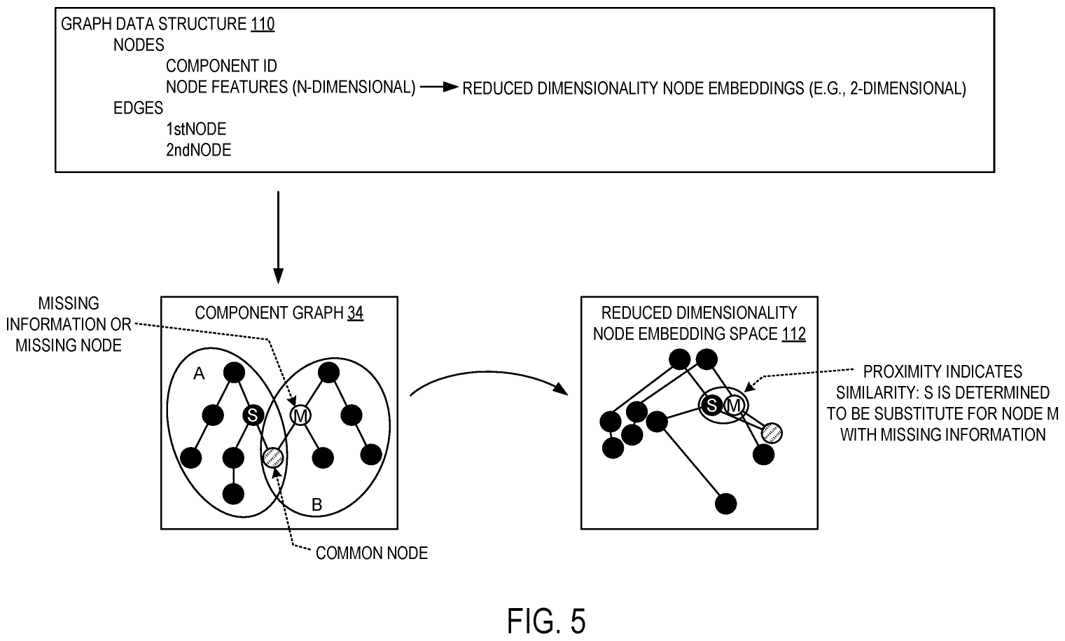

The processor 12 is further configured to receive a source LCA dataset 70 that includes the component IDs 26 along with Full Material Disclosures (FMD) data 74 and environmental impact data, in which there is no FMD data or missing FMD data for the target node in a source LCA dataset. In the depicted example, there is no FMD data or missing FMD data for the component ID #12347 in the source LCA dataset 70. The processor 12 is configured to execute a program to implement an embeddings comparison algorithm 78 to compare embeddings of the component IDs to thereby identify a substitute component ID 82 for the target node on the graph. In this example, the substitute component ID #12367 is identified for the component ID #12347 for substitution. Turning briefly to FIG. 5, shown is an example component graph 34 with the node embeddings 62 in a reduced dimensionally node embedding space 112 identifying the substitute component ID 82 via the system 100. As shown at FIG. 5, the component graph 34 with the node embeddings 62 in the reduced dimensionality node embedding space 112 identifies a substitute node “S” for a node “M” with missing information as the proximity in the component graph 34 indicates similarity. Turning back to FIG. 1, the LCA program 20 is further configured to compute an LCA result 88 using an LCA algorithm 86 based at least upon the substitute component ID 82. It will be appreciated that identifying the substitute component ID may also include identifying a missing component ID. For instance, if the data distance algorithm can find outliers in the embedding data that indicate a specific component has missing or incorrect information, it can be inferred that the embeddings for the part show that it is similar to other parts of a different type rather than the type for which it is categorized.

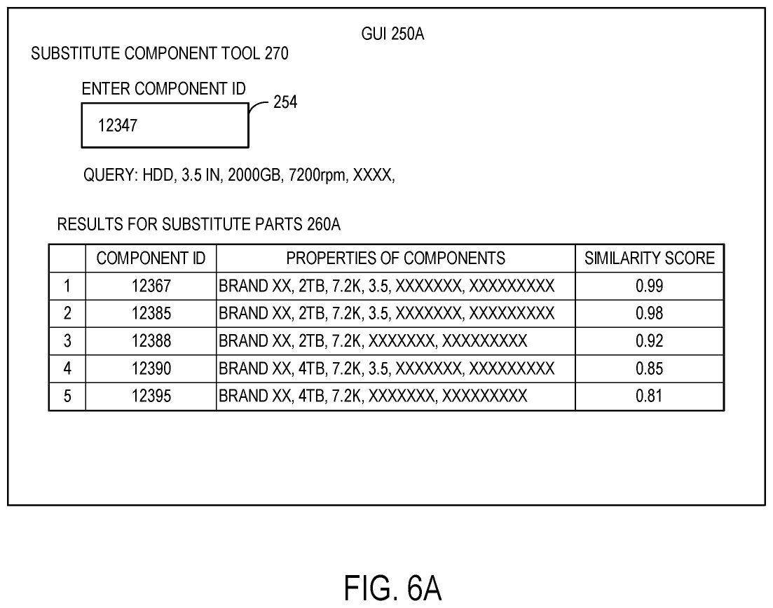

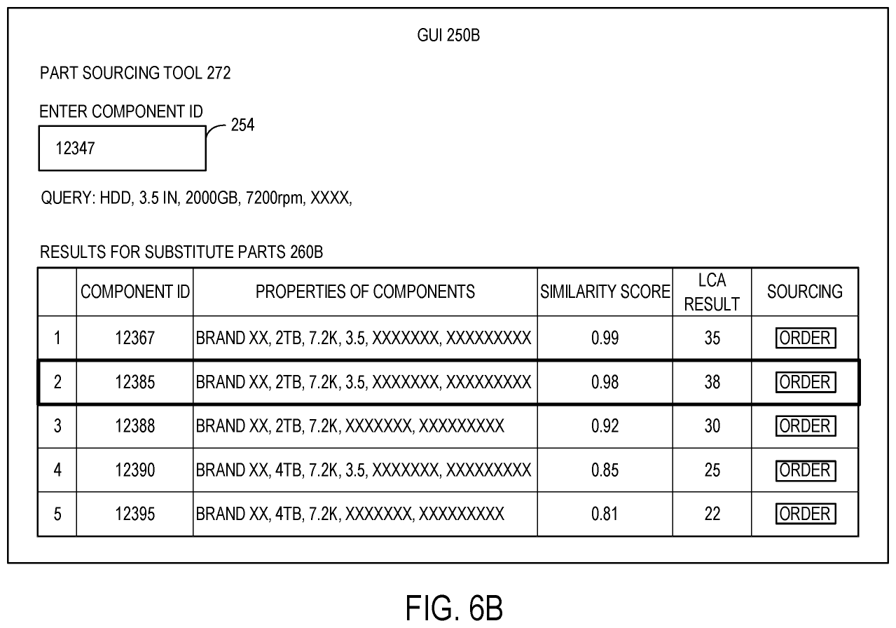

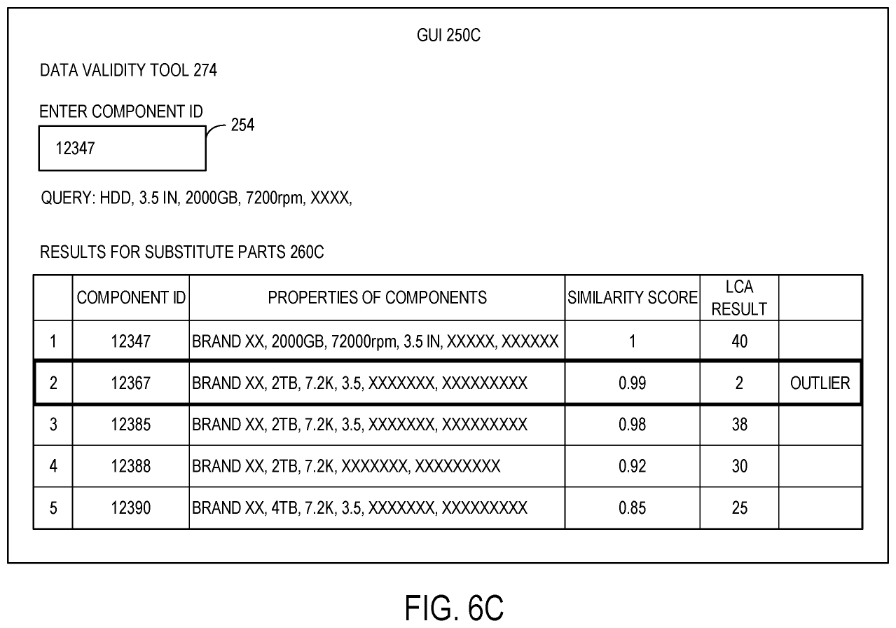

FIGS. 6A-6C show screens of an example graphical user interface (GUI) 250A-C of the LCA program 20 of the system 100 of FIG. 1. FIG. 6A shows a screen of GUI 250A of a substitute component tool 270 of the LCA program 20. The substitute component tool 270 displays the GUI 250A on the client device display and allows a user to enter a component ID into a search box 254, where the user wishes to identify candidate alternative components for the component associated with the component ID entered by the user. Once the search is performed, the tool 270 displays results for substitute parts 260A with a list of the candidate substitute parts in an order of higher confidence (similarity score). In the depicted example, the user enters the component ID of 12347 in the search box 254 of the GUI 250A, which has component properties of “HDD, 3.5 IN, 2000 GB, 7200 rpm, XXX.” The GUI 250A displays the results 260A which include a list of candidate alternative component IDs: 12367, 12385, 12388, 12390, and 12395. The list is ordered by similarity scores with higher scores indicating higher confidence. As shown in the properties of the component ID 12367, the present model is configured to identify alternative components with similar properties even if the units (e.g., 3.5 IN and 3.5, 2000 GB and 2 TB, 7200 rpm and 7.2K) are unknown, different, or incorrect. Furthermore, it will be appreciated that the present model is configured to identify alternative components with similar properties in which there is no exact functional match. In the depicted list of components although a 2 TB hard drive is specified two of the matched hard drives are 4 TB in since. These drives may not be an exact functional match, but since the latter exceeds the capacity of the former, it can be substituted for the former. As yet another example, the components may not be physically compatible or equivalent. For example, the component may be a power supply component such as a resistor having a specific value, such as 4.99 k ohms, and matches of different valued resistors may be shown, such as a 5.49 k ohm resistors. While these resistors might not be functionally interchangeable, for the purposes of LCA analysis, they are similar enough to provide missing FMD data needed to produce an accurate LCA result.

FIG. 6B shows a screen of GUI 250B of a part sourcing tool 272 of the LCA program 20. The part sourcing tool 272 displays the GUI 250B including results for substitute parts 260B with a list of the candidate substitute parts in an order of higher confidence (similarity score) along with the LCA result including environmental impact data in the form of a score (higher is better in this example). The part sourcing tool 272 further displays an icon for “ORDER” that enables a user to order the part by clicking the icon. In this example, component ID 12367 is the closest match according to the similarity score to component ID 12347, however component ID 12385, which also has the second ranked similarity score, has the highest LCA result (see dark rectangle around row), indicating that the component is better for the environment. Thus, the user may select the ORDER selector in the appropriate row to place an order for the component ID 12385. In this way, a user who is sourcing components for a data center server or other assembled product, can use the part sourcing tool 272 to select a more environmentally friendly option.

FIG. 6C shows GUI 250C of a data validity tool 274 of the LCA program 20. The data validity tool 274 displays the GUI 250C including results for substitute parts 260C with a list of the candidate substitute parts in an order of higher confidence (similarity score) along with the LCA result including environmental impact data. The data validity tool 272 further displays an icon for “OUTLIER” that identifies the substitute component ID with the LCA result which is an outlier. Using such the data validity tool 274, a user in charge of verifying the validity of LCA data can quickly identify outliers for which the data indicates an LCA results that widely varies from other similar components, and take measures to correct error when found.

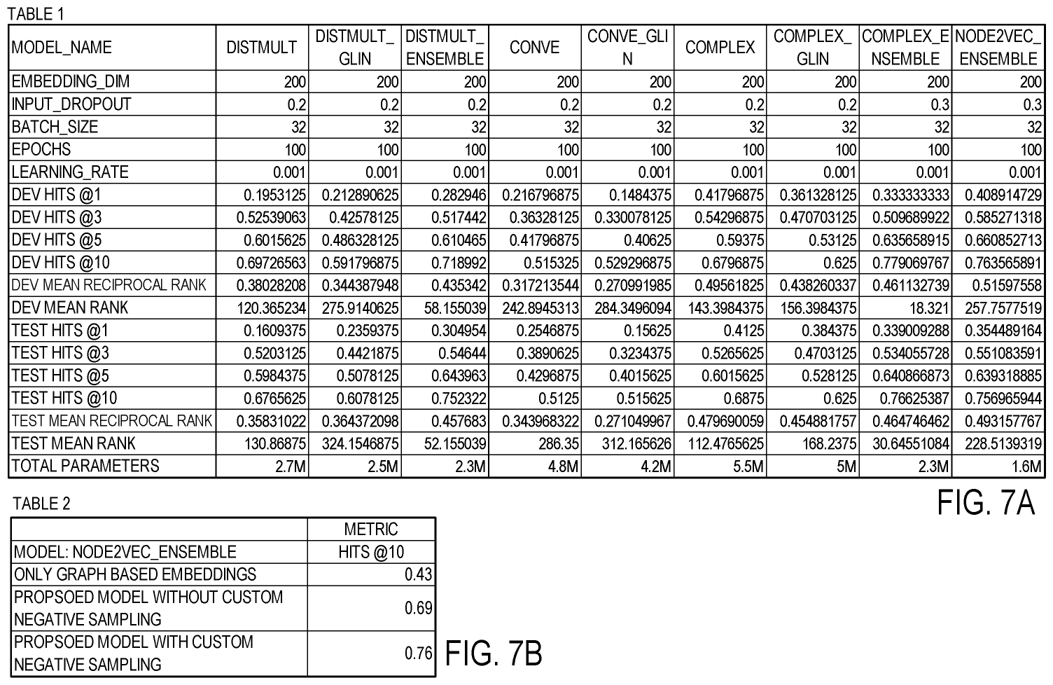

Table 1 of FIG. 7A includes model characteristics of the present trained model of the system 100 of FIG. 1 and other conventional models, compared using a benchmark test. Table 1 shows the performance of the model tested with conventional models using different metrics in the context of one of several different ranking metrics (such as Hit Ratio, Mean Reciprocal Rate, and Mean Rank). The model name with “ENSEMBLE” in Table 1 indicates the extension of the present model to improve conventional models. The present model was tested using a standard machine learning setup for benchmarking. The positive match training data pairs 38A were divided into three sets: training, development and testing positive samples in 70:15:15 ratio. The positive match training data pairs were used to train the ML model 40. The development positive pairs set was used to test the model performance using 174 and the best model was stored based on the maximization of Mean Reciprocal Rate. Finally, the trained model embedding 62 was utilized to test the performance of the model with the testing positive samples. The number of parameters of each model is reported in Table 1. The present model uses fewer parameters than conventional models and provides better accuracy than conventional model setup.

In addition, an ablation study was conducted to study the impact of the negative match training data pairs 38B with random negative sample generation using a computer-assisted random generator. Results of this study are shown in Table 2 of FIG. 7B, which shows improved accuracy using custom negative samples against random negative samples. Table 2 further shows results for models trained only based on the graph embeddings (and thus without training based on the positive/negative training data pairs discussed above), without training using the negative training data pairs discussed above, and with negative training data pairs discussed above, the latter yielding superior performance.

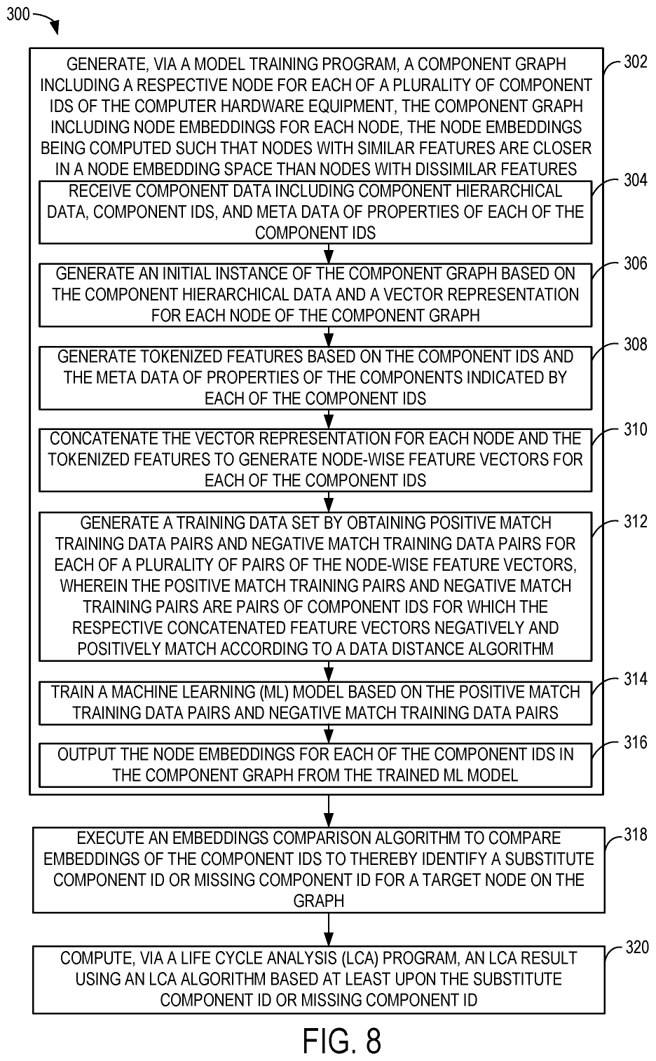

FIG. 8 is a flowchart of a computerized method 300 for predicting substitute or missing parts of an assembled product according to one example configuration of the present disclosure. At step 302, the method 300 may include generating, via a model training program, a component graph including a respective node for each of a plurality of component IDs of the assembled product, the component graph including node embeddings for each node, the node embeddings being computed such that nodes with similar features are closer in a node embedding space than nodes with dissimilar features.

To generate the component graph with node embeddings for each node above, the following steps 304-316 are performed. At step 304, the method may include receiving component data including component hierarchical data, component IDs, and meta data of properties of each of the component IDs.

Continuing from step 304 to step 306, the method 300 may include generating an initial instance of the component graph based on the component hierarchical data and generating a vector representation for each node of the component graph.

Advancing from step 306 to step 308, the method 300 may include generating tokenized features based on the component IDs and the meta data of properties of the components indicated by each of the component IDs.

Proceeding from step 308 to step 310, the method 300 may include concatenating the vector representation for each node and the tokenized features to generate node-wise feature vectors for each of the component IDs.

Continuing from step 310 to step 312, the method 300 may include generating a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm.

Advancing from step 312 to step 314, the method 300 may include training a machine learning (ML) model based on the positive match training data pairs and negative match training data pairs.

Proceeding from step 314 to step 316, the method 300 may include outputting the node embeddings for each of the component IDs in the component graph from the trained ML model.

At step 318, the method 300 may further include executing, via a life cycle analysis (LCA) program, an embeddings comparison algorithm to compare embeddings of the component IDs to thereby identify a substitute component ID for a target node on the component graph.

Proceeding from step 318 to step 320, the method 300 may include computing an LCA result using an LCA algorithm based at least upon the substitute component ID.

The computing system 100 and method 300 described herein provide mechanisms for predicting substitute components of the assembled product. These systems and methods can be used to aid Life Cycle Assessment (LCA) and enable an organization to provide a better assessment of the sustainability of its cloud hardware deployments at scale, even when the organization only possesses incomplete or inaccurate data for some components of the assembled product. By predicting substitute components for which valid data useful in the LCA analysis exists to be used in place of the incomplete or inaccurate data, organizations can perform LCA analysis more accurately to thereby better understand the environmental impact of the assembled product. This enables such organizations to make decisions that reduce the overall environmental impact of the assembled product the organizations deploy by selecting equipment with a reduced environmental impact, minimizing waste, and using their equipment in a manner that increases its lifespan, for example.

In some embodiments, the methods and processes described herein may be tied to a computing system of one or more computing devices. In particular, such methods and processes may be implemented as a computer-application program or service, an application-programming interface (API), a library, and/or other computer-program product.

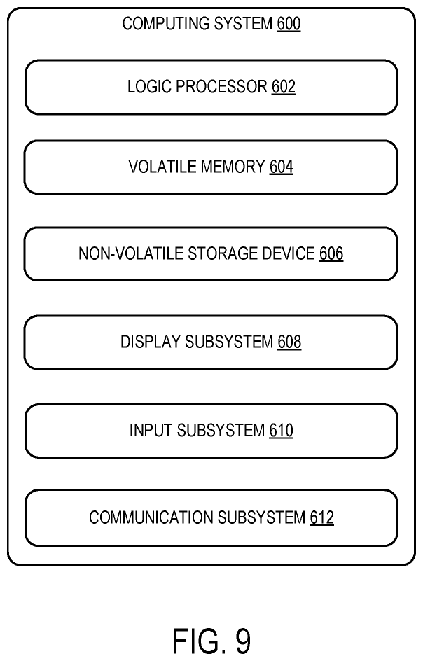

FIG. 9 schematically shows a non-limiting embodiment of a computing system 600 that can enact one or more of the methods and processes described above. Computing system 600 is shown in simplified form. Computing system 600 may embody the computer device 10 described above and illustrated in FIG. 1. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 1.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, camera, microphone, or touch screen, for example.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

The following paragraphs provide additional support for the claims of the subject application. One aspect provides a computing system for predicting substitute or missing parts of an assembled product. The computing system may include a processor having associated memory storing instructions that cause the processor to execute a model training program configured to generate a component graph including a respective node for each of a plurality of component IDs of the assembled product. The component graph may include node embeddings for each node, in which the node embeddings may be computed such that nodes with similar features are closer in a node embedding space than nodes with dissimilar features. The processor may be further configured to execute an embeddings comparison algorithm to compare embeddings of the component IDs to thereby identify a substitute component ID for a target node on the component graph.

According to this aspect, the processor may be further configured to execute a life cycle analysis (LCA) program configured to compute an LCA result using an LCA algorithm based at least upon the substitute component ID.

According to this aspect, to generate the component graph, the model training program may be further configured to receive component data including component hierarchical data, component IDs, and meta data of properties of each of the component IDs. The model training program may be further configured to generate an initial instance of the component graph based on the component hierarchical data. The model training program may be further configured to generate a vector representation for each node of the component graph. The model training program may be further configured to generate tokenized features based on the component IDs and the meta data of properties of the components indicated by each of the component IDs. The model training program may be further configured to concatenate the vector representation for each node and the tokenized features to generate the initial instance of the component graph with node-wise feature vectors for each of the component IDs.

According to this aspect, to generate the component graph, the model training program may be further configured to generate a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm. The model training program may be further configured to train a machine learning (ML) model based on the positive match training data pairs and negative match training data pairs. The model training program may be further configured to output the node embeddings for each of the component IDs in the component graph from the trained ML model.

According to this aspect, there may be no Full Material Disclosures (FMD) data or missing FMD data for the target node in a source LCA dataset.

According to this aspect, the FMD data may be present for the substitute component ID in a modified LCA dataset, in which the LCA model may be fed the modified LCA dataset as input to produce the LCA result.

According to this aspect, the model training program may be further configured to generate the initial instance of the component graph based on the component hierarchical data by identifying a common component and linking a plurality of subgraphs of units of the assembled product equipment via the common component.

According to this aspect, the positive match training data pairs may be obtained when a Jaccard distance is larger than a positive match threshold, and the negative match training data pairs may be obtained when a Jaccard distance is larger than a minimum threshold and less than a negative match threshold for the pair of component IDs.

According to this aspect, the positive match training data pairs may further include the pairs of component IDs included in a ground truth replacement component data set.

According to this aspect, the processor may be further configured to display a graphical user interface (GUI) including a part sourcing tool that shows the substitute component ID with the LCA result, along with other components with similarity scores relative to within a predetermined range and other LCA results for each component, and further including an order selector enabling a user to order the substitute component or one of the other components.

According to this aspect, the processor may be further configured to display a graphical user interface (GUI) including a data validity tool that identifies that the LCA result for the substitute component is an outlier as compared to other LCA scores for other components having similarity scores within a predetermined range with respect to the substitute component.

According to another aspect of the present disclosure, a computerized method for predicting substitute or missing parts of an assembled product is provided. According to this aspect, the computerized method may include generating, via a model training program, a component graph including a respective node for each of a plurality of component IDs of the assembled product, the component graph including node embeddings for each node, the node embeddings being computed such that nodes with similar features are closer in a node embedding space than nodes with dissimilar features. The computerized method may further include executing an embeddings comparison algorithm to compare embeddings of the component IDs to thereby identify a substitute component ID for a target node on the component graph.

According to this aspect, the computerized method may further include computing, via a life cycle analysis (LCA) program, an LCA result using an LCA algorithm based at least upon the substitute component ID.

According to this aspect, the computerized method may further include, to generate the component graph, receiving component data including component hierarchical data, component IDs, and meta data of properties of each of the component IDs. The computerized method may further include generating an initial instance of the component graph based on the component hierarchical data. The computerized method may further include generating a vector representation for each node of the component graph. The computerized method may further include generating tokenized features based on the component IDs and the meta data of properties of the components indicated by each of the component IDs. The computerized method may further include concatenating the vector representation for each node and the tokenized features to generate node-wise feature vectors for each of the component IDs.

According to this aspect, the computerized method may further include, to generate the component graph, generating a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm. The computerized method may further include training a machine learning (ML) model based on the positive match training data pairs and negative match training data pairs. The computerized method may further include outputting the node embeddings for each of the component IDs in the component graph from the trained ML model.

According to this aspect, the component graph may be generated based on the component hierarchical data by identifying a shared component and linking a plurality of subgraphs of units of the assembled product via the shared component.

According to this aspect, the positive match training data may be obtained when a Jaccard distance is larger than a positive match threshold; and the negative match training data pairs may be obtained when a Jaccard distance is larger than a minimum threshold and less than a negative match threshold for the pair of component IDs.

According to this aspect, the positive match training data pairs may further include the pairs of component IDs included in a ground truth replacement component data set.

According to this aspect, there may be no Full Material Disclosures (FMD) data or missing FMD data for the target node in a source LCA dataset.

According to another aspect of the present disclosure, a computer system for predicting substitute or missing parts of an assembled product is provided. The computing system may include a processor having associated memory storing instructions that cause the processor to execute a model training program. The model training program may be configured to receive component data including component hierarchical data, component IDs, and meta data of properties of each of the component IDs. The model training program may be further configured to generate an initial instance of component graph based on the component hierarchical data. The model training program may be further configured to generate tokenized features based on the component IDs and the meta data of properties of the components indicated by each of the component IDs. The model training program may be further configured to generate node-wise feature vectors for each of the component IDs based on the initial instance of the component graph and the tokenized features. The model training program may be further configured to generate a training data set by obtaining positive match training data pairs and negative match training data pairs for each of a plurality of pairs of the node-wise feature vectors, in which the positive match training pairs and negative match training pairs may be pairs of component IDs for which the respective concatenated feature vectors negatively and positively match according to a data distance algorithm. The model training program may be further configured to train a machine learning (ML) model based on the positive match training data pairs and negative match training data pairs to output the node embeddings for each of the component IDs in the component graph from the trained ML model. The model training program may be further configured to generate, via the trained ML model, the component graph including a respective node for each of a plurality of component IDs of the assembled product based on the component data, the component graph including node embeddings for each node, the node embeddings being computed such that nodes with similar features are closer in a node embedding space than nodes with dissimilar features. The processor may be further configured to execute an embeddings comparison algorithm to compare embeddings of the component IDs to thereby identify a substitute component ID for a target node on the graph. The processor may be further configured to execute a life cycle analysis (LCA) program configured to compute an LCA result using an LCA algorithm based at least upon the substitute component ID.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for predicting substitute or missing parts of an assembled product, the computing system comprising a processor having associated memory storing instructions that cause the processor to:
execute a model training program configured to generate a component graph including a respective node for each of a plurality of component IDs of the assembled product, the component graph including node embeddings for each node, the node embeddings being computed such that nodes with similar features are closer in a node embedding space than nodes with dissimilar features; and
execute an embeddings comparison algorithm to compare embeddings of the component IDs to thereby identify a substitute component ID for a target node on the component graph.

2. The computing system of claim 1, wherein the processor is further configured to execute a life cycle analysis (LCA) program configured to compute an LCA result using an LCA algorithm based at least upon the substitute component ID.

3. The computing system of claim 1, wherein, to generate the component graph, the model training program is further configured to:
receive component data including component hierarchical data, component IDs, and meta data of properties of each of the component IDs;
generate an initial instance of the component graph based on the component hierarchical data;
generate a vector representation for each node of the component graph;
generate tokenized features based on the component IDs and the meta data of properties of the components indicated by each of the component IDs; and
concatenate the vector representation for each node and the tokenized features to generate the initial instance of the component graph with node-wise feature vectors for each of the component IDs.

4. The computing system of claim 3, wherein, to generate the component graph, the model training program is further configured to:
generate a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm;
train a machine learning (ML) model based on the positive match training data pairs and negative match training data pairs; and
output the node embeddings for each of the component IDs in the component graph from the trained ML model.

5. The computing system of claim 2, wherein there is no Full Material Disclosures (FMD) data or missing FMD data for the target node in a source LCA dataset.

6. The computing system of claim 5, wherein the FMD data is present for the substitute component ID in a modified LCA dataset, wherein the LCA model is fed the modified LCA dataset as input to produce the LCA result.

7. The computing system of claim 3, wherein the model training program is configured to generate the initial instance of the component graph based on the component hierarchical data by identifying a common component and linking a plurality of subgraphs of units of the assembled product equipment via the common component.

8. The computing system of claim 4, wherein
the positive match training data pairs are obtained when a Jaccard distance is larger than a positive match threshold; and
the negative match training data pairs are obtained when a Jaccard distance is larger than a minimum threshold and less than a negative match threshold for the pair of component IDs.

9. The computing system of claim 4, wherein the positive match training data pairs further include the pairs of component IDs included in a ground truth replacement component data set.

10. The computing system of claim 2, wherein the processor is further configured to display a graphical user interface (GUI) including a part sourcing tool that shows the substitute component ID with the LCA result, along with other components with similarity scores relative to within a predetermined range and other LCA results for each component, and further including an order selector enabling a user to order the substitute component or one of the other components.

11. The computing system of claim 1, wherein the processor is further configured to display a graphical user interface (GUI) including a data validity tool that identifies that the LCA result for the substitute component is an outlier as compared to other LCA scores for other components having similarity scores within a predetermined range with respect to the substitute component.

12. A computerized method for predicting substitute or missing parts of an assembled product, comprising:
generating, via a model training program, a component graph including a respective node for each of a plurality of component IDs of the assembled product, the component graph including node embeddings for each node, the node embeddings being computed such that nodes with similar features are closer in a node embedding space than nodes with dissimilar features; and
executing an embeddings comparison algorithm to compare embeddings of the component IDs to thereby identify a substitute component ID for a target node on the component graph.

13. The method of claim 12, further comprising,
computing, via a life cycle analysis (LCA) program, an LCA result using an LCA algorithm based at least upon the substitute component ID.

14. The method of claim 12, further comprising, to generate the component graph:
receiving component data including component hierarchical data, component IDs, and meta data of properties of each of the component IDs;
generating an initial instance of the component graph based on the component hierarchical data;
generating a vector representation for each node of the component graph;
generating tokenized features based on the component IDs and the meta data of properties of the components indicated by each of the component IDs; and
concatenating the vector representation for each node and the tokenized features to generate node-wise feature vectors for each of the component IDs.

15. The method of claim 14, further comprising, to generate the component graph:
generating a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm;
training a machine learning (ML) model based on the positive match training data pairs and negative match training data pairs; and
outputting the node embeddings for each of the component IDs in the component graph from the trained ML model.

16. The method of claim 14, wherein the component graph is generated based on the component hierarchical data by identifying a shared component and linking a plurality of subgraphs of units of the assembled product via the shared component.

17. The method of claim 15, wherein
the positive match training data are obtained when a Jaccard distance is larger than a positive match threshold; and
the negative match training data pairs are obtained when a Jaccard distance is larger than a minimum threshold and less than a negative match threshold for the pair of component IDs.

18. The method of claim 17, wherein the positive match training data pairs further include the pairs of component IDs included in a ground truth replacement component data set.

19. The method of claim 13, wherein there is no Full Material Disclosures (FMD) data or missing FMD data for the target node in a source LCA dataset.

20. A computing system for predicting substitute or missing parts of an assembled product, the computing system comprising a processor having associated memory storing instructions that cause the processor to:
execute a model training program configured to:
receive component data including component hierarchical data, component IDs, and meta data of properties of each of the component IDs;
generate an initial instance of component graph based on the component hierarchical data;
generate tokenized features based on the component IDs and the meta data of properties of the components indicated by each of the component IDs;
generate node-wise feature vectors for each of the component IDs based on the initial instance of the component graph and the tokenized features;
generate a training data set by obtaining positive match training data pairs and negative match training data pairs for each of a plurality of pairs of the node-wise feature vectors, wherein the positive match training pairs and negative match training pairs are pairs of component IDs for which the respective concatenated feature vectors negatively and positively match according to a data distance algorithm;
train a machine learning (ML) model based on the positive match training data pairs and negative match training data pairs to output the node embeddings for each of the component IDs in the component graph from the trained ML model; and
generate, via the trained ML model, the component graph including a respective node for each of a plurality of component IDs of the assembled product based on the component data, the component graph including node embeddings for each node, the node embeddings being computed such that nodes with similar features are closer in a node embedding space than nodes with dissimilar features;
execute an embeddings comparison algorithm to compare embeddings of the component IDs to thereby identify a substitute component ID for a target node on the graph; and
execute a life cycle analysis (LCA) program configured to compute an LCA result using an LCA algorithm based at least upon the substitute component ID.
